(19) United States
(12) Patent Application Publication
(10) Pub. No.: US 2010/0051165 A1
(43) Pub. Date: Mar. 4, 2010

(54) ELECTROGRAPHIC DIGITALLY PATTERNING OF METAL FILMS

(76) Inventors: Thomas N. Tombs, Rochester, NY (US); Dinesh Tyagi, Fairport, NY (US); Arun Chowdry, Pittsford, NY (US); Leonard R. Christopher, Palmyra, NY (US)

Correspondence Address: EASTMAN KODAK COMPANY;PATENT LEGAL STAFF, 343 STATE STREET, ROCHESTER, NY, 14650-2201, US

(21) Appl. No.: 12/199,939

(22) Filed: Aug. 28, 2008

(51) Int. Cl. B32B 37/02; G03G 15/00

(52) U.S. Cl. 156/60; 156/64; 156/378; 399/38

(57) ABSTRACT

Electrographic printing of one or more toner layers having a particular pattern by electrographic techniques so that one layer acts as an adhesive, when fixed, for a thin film. Such electrographic printing comprises the steps of forming a desired print image, electrographically, on a receiver member utilizing marking particles; and applying the thin film in registration before activating the toner.

### FIELD OF THE INVENTION

This invention relates in general to electrographic printing, and more particularly to printing with metallic thin film elements and, in one embodiment, to electrographic patterning of electrically-conductive thin films comprising a support, and a digitally patterned electrically-conductive layer. More specifically, this invention relates to using electrographic imaging processes employing electrographic toners where the image patterns are created using marking or non marking toner particles.

### BACKGROUND OF THE INVENTION

One method for printing images on a receiver member is referred to as electrography. In this method, an electrostatic image is formed on a dielectric member by uniformly charging the dielectric member and then discharging selected areas of the uniform charge to yield an image-wise electrostatic charge pattern. Such discharge is typically accomplished by exposing the uniformly charged dielectric member to actinic radiation provided by selectively activating particular light sources in an LED array or a laser device directed at the dielectric member. After the image-wise charge pattern is formed, the pigmented (or in some instances, non-pigmented) marking particles are given a charge, substantially opposite the charge pattern on the dielectric member and brought into the vicinity of the dielectric member so as to be attracted to the image-wise charge pattern to develop such pattern into a visible image.

Thereafter, a suitable receiver member (e.g., a cut sheet of plain bond paper) is brought into juxtaposition with the marking particle developed image-wise charge pattern on the dielectric member. A suitable electric field is applied to transfer the marking particles to the receiver member in the image-wise pattern to form the desired print image on the receiver member. The receiver member is then removed from its operative association with the dielectric member and the marking particle print image is permanently fixed to the receiver member typically using heat, and/or pressure and heat. Multiple layers or marking materials can be overlaid on one receiver, for example, layers of different color particles can be overlaid on one receiver member to form a multi-color print image on the receiver member after fixing.

Metal films, such as aluminum and gold, are commonly used in the manufacture of metal coated printed articles and electrical circuits in the commercial printing business. Currently there are commercial devices that stamp metal films, including a wide variety of reflective and electrically conductive thin films on various substrates. There is a critical need in the art for a technique to create patterned conductive or reflective thin film structures in a cost effective manner for short runs or with variable information. In addition to providing superior electrode performance, these thin film conductive layers also must be digitally patterned, must resist the effects of humidity change, and be manufacturable at a reasonable cost.

It is toward the objective of providing both such improved decorative reflective articles as well as electrically conductive, digitally patterned thin film coated articles that more effectively meet the diverse commercial needs than those of the prior art, that the present invention is directed.

The tin film layer(s) of this invention are patterned by application of one of more toners using the electrographic development process. The final pattern is “fixed” by means of pressure and (or) heat fixing step, whereupon the toner particles interacts with the thin film layer to adhere the thin film to a substrate.

### SUMMARY OF THE INVENTION

In view of the above, this invention is directed to electrographic printing using both toner and films to form one or more layers, with a particular pattern, which can be printed by electrographic techniques. Such electrographic printing includes the steps of forming a desired image, electrographically or with inkjet, on a receiver member and using that image to selectively adhere one or more thin films into a desired in registration design. The patterning process of this invention combines the application of electrophotographic marking toner and thin metal films that are applied in conjunction with the EP printing process.

The device and related method control registration by using a registration mark assigned for each sheet or set of sheets and defined with respect to its position. The marks are applied to a substrate or to a support for the substrates or sheets with a specified distance relative to the thin film

### BRIEF DESCRIPTION OF THE DRAWINGS

In the detailed description of the preferred embodiment of the invention presented below, reference is made to the accompanying drawings, in which:

FIG. 1 is a schematic side elevational view, in cross section, of an electrographic reproduction apparatus suitable for use with this invention.

FIG. 2 is a detailed schematic side elevational view, in cross section, of another embodiment of the electrographic reproduction apparatus of FIG. 1.

FIG. 3 is a schematic side elevational view, in cross section, of another embodiment of the electrographic reproduction apparatus.

FIG. 4 show schematics side elevational view, in cross section, of two embodiments of a film application module of the electrographic reproduction apparatus of FIG. 1, on an enlarged scale.

FIG. 5 is a schematic side elevational view, in cross section, of one printing module of the electrographic reproduction apparatus of FIG. 1, on an enlarged scale.

FIG. 6 is a schematic showing sheets on a transport belt in a printer.

FIG. 7 is a flow diagram of the device and system of the present invention.

FIG. 8 shows block diagram of an embodiment of the device and system.

FIG. 9 is an embodiment of a method printing a patterned thin film upon a receiver.

FIG. 10 is another embodiment of a method printing a patterned thin film upon a receiver.

### DETAILED DESCRIPTION OF THE INVENTION

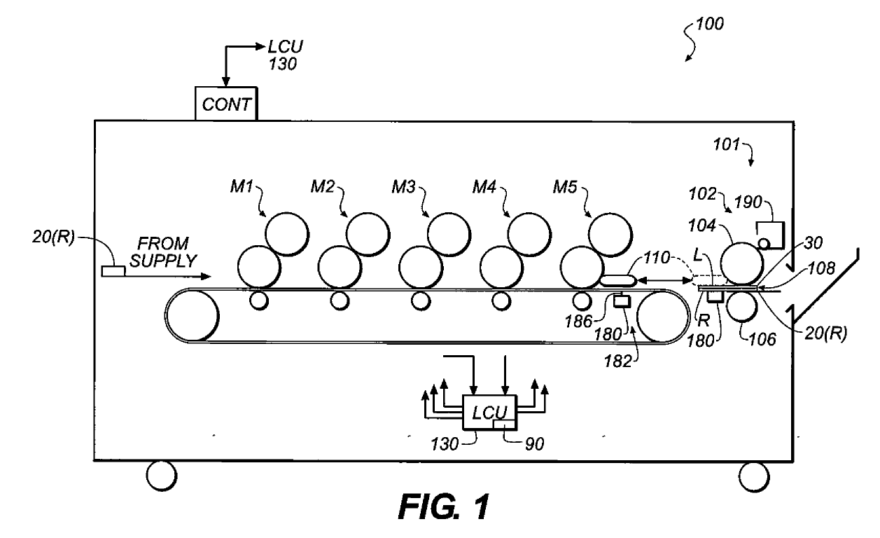

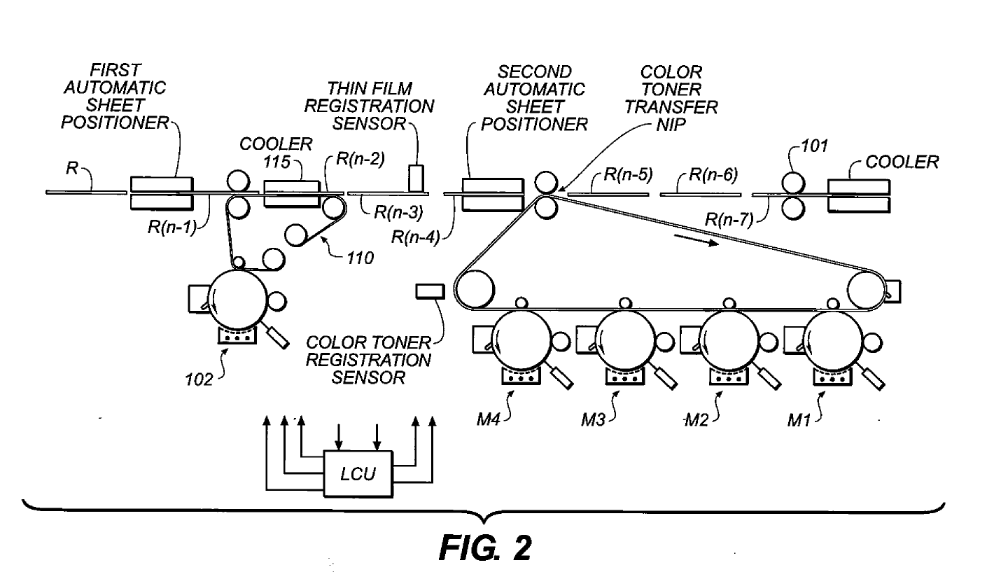

Referring now to the accompanying drawings, FIGS. 1 and 2 are side elevational views schematically showing portions of an electrographic print engine or printer apparatus suitable for printing of thin film layered prints. One embodiment of the invention involves printing using an electrophotographic engine having five image printing stations or modules arranged in tandem and an optional finishing assembly. The invention contemplates that more or less than five stations may be combined to deposit toner and apply one or more layers of a thin film 10 on a single receiver member 20 (R) to produce digitally patterned thin film print 50, or may include other typical electrographic writers, printer apparatus, or other finishing devices. In fact in some applications there is only need for one printing station or module as long as that module can supply a toner that will act as an adhesive when fused.

An electrographic printer apparatus 100 has one or more printing modules shown here as five tandemly arranged electrostatographic image forming printing modules M1, M2, M3, M4, and M5 and a finishing assembly 101, that in one embodiment includes a thin film applicator 102 so that the film is activated by the digitally patterned image in a fuser at the same time the film is applied. Additional modules may be provided. Each of the printing modules generates a single-color toner image for transfer to a receiver member successively moved through the modules. The finishing assembly has a fuser roller 104 and an opposing pressure roller 106 that form a fusing nip 108 there between. The printer shown also includes a film application device 110. The receiver member 20 (R), during a single pass through the five modules, can have transferred, in registration with the help of a register device or registration method 60, up to five single-color toner images to form a pentachrome image. As used herein, the term pentachrome implies that in an image formed on a receiver member combinations of subsets of the five colors are combined to form other colors on the receiver member at various locations on the receiver member, and that all five colors participate to form process colors in at least some of the subsets wherein each of the five colors may be combined with one or more of the other colors at a particular location on the receiver member to form a color different than the specific color toners combined at that location.

In one embodiment, printing module M1 forms black (K) toner color separation images, M2 forms yellow (Y) toner color separation images, M3 forms magenta (M) toner color separation images, and M4 forms cyan (C) toner color separation images. Printing module M5 may form any other fifth color separation image or be clear. It is shown here as a color toner or clear toner that acts as a thin film adhesive (A) when activated by heat, pressure or other known method. In the electrographic printer apparatus, the toner in M5 lays down a pattern which is used as the film image pattern since the toner 30, described in detail below, acts as a thin film adhesive. Accordingly in the patterned areas are laid down in a pattern of toner 40, contacted by the thin film layer 10 and activated by heat, pressure and/or other activation methods to produce a digitally patterned thin film print 50 useful for decorative images, such as logos, for image protective purposes, for scratch offs and embossing and/or for conductive or electrical purposes. In the embodiment shown in FIG. 1 the M5 module puts down the toner that acts as an adhesive for the thin film and the thin film applicator 102 applies the thin film 30 between M5 and the fuser roller 104. The toner, thin film and/or substrate may be cooled (not shown) prior to the separation of the thin film support from the substrate. Registration marks 136 are applied and scanned prior to M5 and corrections are then made based on the data from the scanned registration marks 136 so that the images created in M1-5 are more accurately registered to the thin film.

In this embodiment, where the color toner is not fused before the application of the thin film, it is important to stabilize the color image so it does not interfere with the thin film application process. A first method is to use a UV curable color toner for the non-film patterned image and cross linking this first toner before the thin film is applied and fused to the toner. A cold stamping foil, such as the Kurz Alufin® foil, would be used as a foil that would work well in this method. Alternatively the thin film patterned image can be laid down in an inverse manner forming essentially a negative image of the desired image that will prevent the thin film from adhering where the toner is laid down and allow all the toner to be fused at the same time. An example of a toner that would work well as the negative image thin film toner is the wax-based toner, as is described below in more detail. A hot stamping foil would be used as a foil that would work well in this method, such as the Kurz hot stamp foils.

The embodiment shown in FIG. 2 shows a second automatic sheet positioner that uses information from both the thin film registration sensor and the color toner registration sensor to control both the position and timing of the receiver so that the thin film image is registered to the color toner image that will be applied in the subsequent color toner transfer nip. The position adjustment adjusts for skew and cross track alignment and the timing adjustment enables the paper to be delivered to the color toner transfer nip so that it is accurately registered in the in track direction. The first automatic sheet positioner adjusts the receiver so that the thin film image is accurately registered to the receiver: in track, cross track, and skew adjustments can be made.

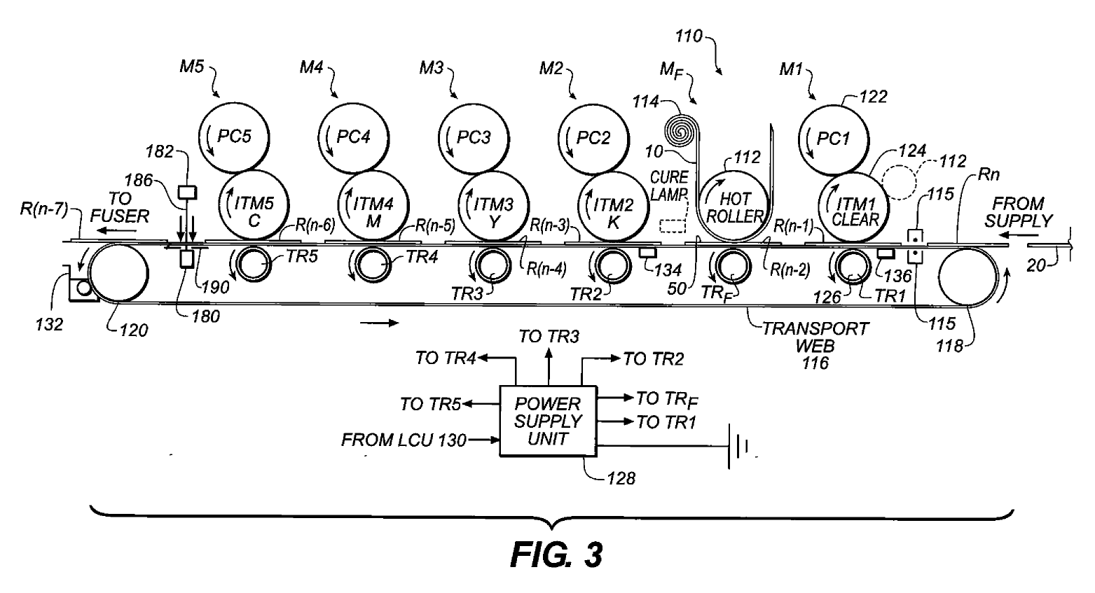

FIG. 3 shows another embodiment for producing the thin metal film patterned print 50 or document image. In this embodiment printing module M1 deposits clear and M2 forms black (K) toner color separation images, M3 forms yellow A) toner color separation images, M4 forms magenta (M) toner color separation images, and M5 forms cyan (C) toner color separation images. Optional printing module M6 (not shown) may form any color such as red, blue, green or any other fifth color separation image or even a gloss finish or another film. In this embodiment the printer includes another module M_{F} that includes the thin film application device 110 to contact the thin film 10 as described below. The thin film application device 110 has a heated roller 112 and a film supply roller 114. The thin film is preferably in the form of a roll but could also be in sheet form where one sheet of a stack is used per print. The digitally patterned thin film print 50 described herein can be incorporated into multilayer structures in any of various configurations depending upon the requirements of the specific application. The digitally patterned thin film 30 can be applied on either or both sides of a receiver or other support.

Receiver members (Rn-R(n-7), where n is the number of stations as shown in FIGS. 2 and 3, are delivered from a paper supply unit (not shown) and transported through the printing modules M1-M5 and film applicator module 110 (M_{F} and Rn-2) in a direction indicated. The receiver members are adhered (e.g., preferably electrostatically via coupled corona tack-down chargers 115) to an endless transport web 116 entrained and driven about rollers 118, 120. Each of the printing modules M1-M5 similarly includes a photoconductive imaging roller, an intermediate transfer member roller, and a transfer backup roller. Thus in printing module M1, a black color toner separation image can be created on the photoconductive imaging roller PC1 (122), transferred to intermediate transfer member roller ITM1 (124), and transferred again to a receiver member moving through a transfer station, which includes ITM1 forming a pressure nip with a transfer backup roller TR1 (126). Similarly, printing modules M2, M3, M4, and M5 include, respectively: PC2, ITM2, TR2; PC3, ITM3, TR3; PC4, ITM4, TR4; and PC5, ITM5, TR5. A receiver member, Rn, arriving from the supply, is shown passing over roller 118 for subsequent entry into the transfer station of the first printing module, M1, in which the preceding receiver member R(n-1) is shown. Similarly, receiver members R(n-2), R(n-3), R(n-4), R(n-5) and R(n-6) are shown moving respectively through the transfer stations of printing modules M2, M3, M4, M5 and the thin film application device 110. An unfused image formed on receiver member R (n-7) is moving, as shown, towards one or more finishing assemblies that includes a fuser, such as those of well known construction, and/or other finishing assemblies in parallel or in series, and can also include one or more additional thin film applicator devices 110 (shown in FIG. 1). Alternatively the film applicator 10 can be located adjacent to any of the other print modules, Mn in an arrangement similar to that shown in FIG. 2.

A power supply unit 128 provides individual transfer currents to the transfer backup rollers TR1, TR2, TR3, TR4, and TR5 respectively. A logic and control unit 130 (FIG. 1) in response to signals from various sensors associated with the electrophotographic printer apparatus 100 provides timing and control signals to the respective components to provide control of the various components and process control parameters of the apparatus in accordance with well understood and known employments. A cleaning station 132 for transport web 116 is also typically provided to allow continued reuse thereof. This printer can be used in conjunction with one or more sensors 134 and/or registration references 136 as well as other references that are used during deposition of each layer of toner, which is laid down relative to one or more registration references, such as a registration pattern.

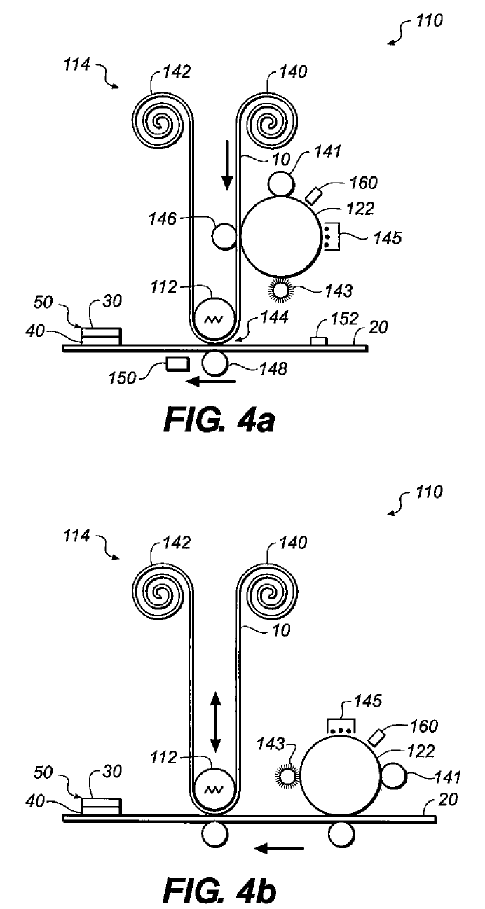

FIGS. 4a and 4b show two embodiments of a thin film application device 110, including the thin film applicator 102, located next to one or more heated roller(s) 112, shown here as internally heated, and the film supply device 114. The thin film applicator 102 has a set of driven inlet rollers 140 and a set of outlet rollers 142. Alternatives include a stamp machine and other thin film applicators. In the thin film application device 110 the thin film material 10 is drawn from a roll 140 to a pick-up roller 142 in the supply device 114 and laid on a surface of the receiver 20 adjacent the heated roller 112 at the nip 144. After the thin film 10 is applied the receiver progresses on in the printer as shown in FIG. 2. The toner, thin film and/or substrate is preferably cooled by cooler 115 (shown in FIG. 2) prior to the separation of the thin film support from the receiver or substrate. In this embodiment the thin film application device 110 also includes a photoconductor 122, toner roller 141, cleaner 143, charger 145, a back-up roller 146 and a pressure roller 148 to form the nip 144. If the thin film application device 110 operates at a faster speed than other parts of the printer then a buffer can be used to accommodate any differences in speed. Optionally other rollers can be added as needed to correct any positional problems, such as deskewing rollers (not shown). The thin film application device is preferably driven at the same operational speed as the printer. Completing the thin film application module is a sensor 150 that issues a signal to controller 130 upon the passage of the trailing edge of the receiver 20 and also controls registration by use of one or more registration marks 152.

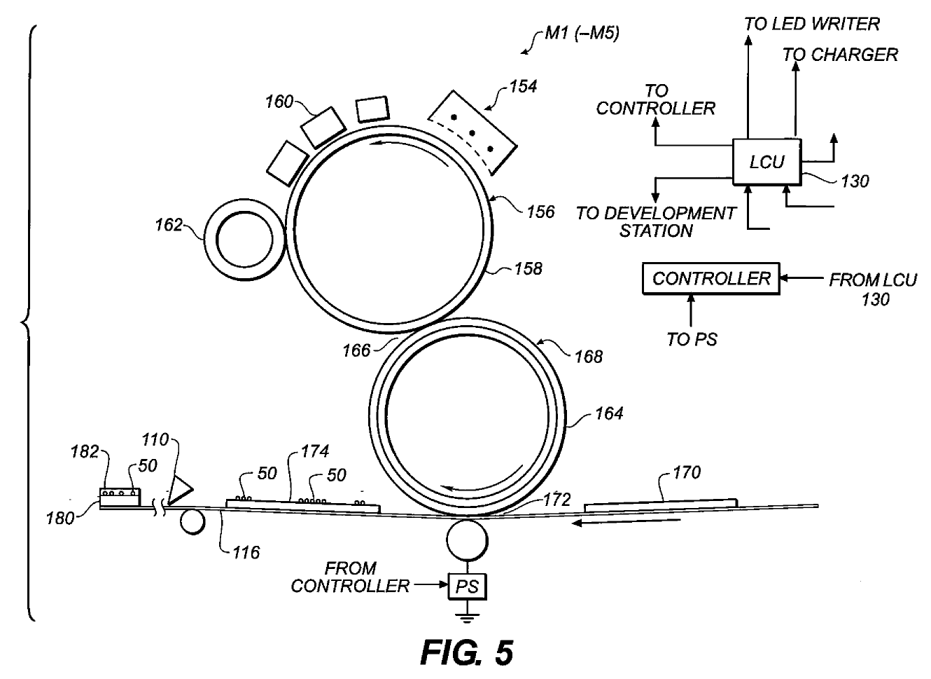

FIG. 5 shows a representative printing module that can apply a pigmented or clear toner 40 in the thin film application device 110 shown. Each printing module of the electrographic printer apparatus 100 includes a plurality of electrographic imaging subsystems for producing one or more multilayered image or pattern. Included in each printing module is a primary charging subsystem 154 for uniformly electrostatically charging a surface 156 of a photoconductive imaging member (shown in the form of an imaging cylinder 158). An exposure subsystem 160 is provided for image-wise modulating the uniform electrostatic charge by exposing the photoconductive imaging member to form a latent electrostatic multi-layer (separation) image of the respective layers. A development station subsystem 162 is used to develop the image-wise exposed photoconductive imaging member. An intermediate transfer member 164 is provided for transferring the respective layer (separation) image from the photoconductive imaging member through a transfer nip 166 to the surface 168 of the intermediate transfer member 164 and from the intermediate transfer member 164 to a receiver member (receiver memberl70 shown prior to entry into the transfer nip 172 and receiver member 174 shown subsequent to transfer of the multilayer (separation) image) which receives the respective (separation) images in superposition to form a composite image 176 thereon and adhesion, such as with clear toner as described above. Receiver member 180 shown subsequent to the transfer of the thin film toner pattern 30 and the thin film application device yielding a thin film layer, shown here as a metal conductive film layer 182.

The logic and control unit (LCU) 130 includes a microprocessor incorporating suitable look-up tables and control software, which is executable by the LCU 130. The control software is preferably stored in memory associated with the LCU 130. Sensors 134 associated with the fusing assembly provide appropriate signals to the LCU 130. In response to sensors 134, the LCU 130 issues command and control signals that adjust the heat and/or pressure within fusing nip 108 and otherwise generally nominalizes and/or optimizes the operating parameters and to reduce errors which are attributable to the printing process and more particularly to the film application. Also feedback from the sensors associated with the fusing and glossing assemblies provide appropriate signals to the LCU 130. The film applicator device 110 can also have separate controls providing control over temperature of the application roller and the downstream cooling of the film and control of application nip pressure for the film applicator.

Subsequent to transfer of the respective (separation) multilayered images, overlaid in registration, one or more of the respective printing modules M1-M5, the receiver member is advanced to a finishing assembly 101 (shown in FIG. 1) including one or more fusers to optionally fuse the multilayer toner image to the receiver member resulting in a receiver product, also referred to as a patterned thin film print 50. The digitally patterned thin film print 50 may be produced by placing such that the thin film layer 30 down prior to fusing or after the initial fusing. The thin film, in one embodiment, can have a thickness that is less than 1 micrometer, preferably important that the thin film, also sometimes referred to as a metal film, can be adhered with the thin film toner adhesive.

The toner used as the thin film toner adhesive can be the Kodak EP toner or Kodak chemically prepared dry ink (CD1). The toner used to form the final thin film pattern layers can be styrenic (styrene butyl acrylate) type used in toner with a polyester toner binder. In that use typically the refractive index of the polymers used as toner resins have are 1.53 to almost 1.102. These are typical refractive index measurements of the polyester toner binder, as well as styrenic (styrene butyl acrylate) toner. Typically the polyesters are around 1.54 and the styrenic resins are 1.59. The conditions under which it was measured (by methods known to those skilled in the art) are at room temperature and about 590 nm. One skilled in the art would understand that other similar materials could also be used. Electrographic (EP) marking particles can be deposited in accordance with an image pattern upon a receiver thin film surface to define the electrode pattern after development. The phrase “electrographic marking particles” is used herein broadly to include electrically photosensitive particles used in migration imaging processes and any other material used to develop and define an electrographic image pattern such as, for an example, electrographic toners, liquid droplets, resin or polymer particles. Such marking particles may be a composite particle and may contain a colorant.

The marking particle or toner is typically, although not necessarily, brought into contact with the image pattern in an electrogaphic developer composition comprising a carrier vehicle and the marking particle. The phrase “electrographic developer composition” includes any composition comprising a carrier and the electrographic marking particles of the present invention and is intended for use in developing electrographic image patterns, however formed, including but not limited to, the methods of electrophotographic, electrophoretic migration imaging and modulated electrostatic printing. In general, the novel electrographic marking particles of the present invention can be used to imagewise deliver a desired concentration of the conductivity modifier regardless of how the image pattern is formed if the image pattern is developed with marking particles.

The thin film layer(s) of this invention are patterned by application of one of more toners using the electrographic development process. These toners use electrographic marking toner particles as described in U.S. Pat. No. 5,948,585 hereby incorporated by reference. Some of these limited coalescence techniques used to prepare CDI are described in patents pertaining to the preparation of electrostatic toner particles because such techniques typically result in the formation of toner particles having a substantially uniform size and uniform size distribution. Representative limited coalescence processes employed in toner preparation are described in U.S. Pat. Nos. 4,833,018 and 4,965,131, hereby incorporated by reference. In one example a pico high viscosity toner, of the type described above, could form the first and or second layers and the top layer could be a laminate or an 8 micron clear toner in the fifth station thus the highly viscous toner would not fuse at the same temperature as the other toner.

In the limited coalescence techniques described, the judicious selection of toner additives such as charge control agents and pigments permits control of the surface roughness of toner particles by taking advantage of the aqueous organic interphase present. It is important to take into account that any toner additive employed for this purpose that is highly surface active or hydrophilic in nature may also be present at the surface of the toner particles. Particulate and environmental factors that are important to successful results include the toner particle charge/mass ratios (it should not be too low), surface roughness, poor thermal transfer, poor electrostatic transfer, reduced pigment coverage, and environmental effects such as temperature, humidity, chemicals, radiation, and the like that affects the toner or paper. Because of their effects on the size distribution they should be controlled and kept to a normal operating range to control environmental sensitivity. This toner also has a tensile modulus (103 psi) of 150-500, normally 345, a flexural modulus (10³ psi) of 300-500, normally 340, a hardness of M70-M72 (Rockwell), a thermal expansion of 68-70 10⁻⁶/degree Celsius, a specific gravity of 1.2 and a slow, slight yellowing under exposure to light according to J. H. DuBois and F. W. John, eds., in Plastics, 5^{th} edition, Van Norstrand and Reinhold, 1974 (page 522).

An important aspect of the process is the accurate registration process. In the registration process of the electrophotographic (EP) printer 100 there is for each sheet at least one register mark, such as per color printing unit, of the multi-color printing machine. The registration mark is produced and assigned to each sheet and defined with respect to its position, preferably relative to one of the marks themselves as applied to FIG. 3. It is notable that when an in-line film applicator is used the receiver remains in registration throughout the process of color toner lay down, thin film application and fusing. In this situation one sensor for the toner registration relative positions would be adequate although others could be used to monitor other registration concerns. The marks are applied preferably to a support for the sheets and preferably downstream of the respectively associated sheet, and, based on the determination of the position of the register marks of a sheet using various methods, for example a circumferential register where at least one sheet is controlled when the sheet following the sheet associated with the determined register marks are downstream in the printing process as described in U.S. application Ser. No. 11/577,675 filed Apr. 20, 2007 and U.S. application Ser. No. 11/847,868 filed Aug. 30, 2007, each of which are incorporated by reference.

In one embodiment, as illustrated in FIGS. 1 and 2, the printing method for producing a registered thin film digitally patterned image upon a receiver includes the steps of depositing a digitally patterned layer of toner to form a predetermined adhesive image that represents a thin film digitally patterned image comprising applying one or more marks to the support for said sheets downstream of the respectively associated first sheet and applying at least one register mark for the first sheet that is to have a thin film applied thereunto and defined with respect to the register mark position on the support, monitoring a thin film registration (application position) by analyzing the relative positions of the sheet register marks and the thin film register marks, controlling the printing process by correcting the thin film registration using a position controller responsive to thin film registration, applying the thin film layer over the digitally patterned image layer an a sheet based on the thin film registration, and activating the digitally patterned image layer to adhere said thin film layer to create said thin film digitally patterned image by applying heat and/or pressure to adhere the thin film at desired locations. This method can be modified by determining if there is a systematic drift and introducing a correction factor in a control step. The method possibly modified by also determining if a weighting would improve registration and if so using a weighting factor that is increased by an increase of the elapsed time (Δt) between a current first control step (i) and a previous control step (i-1).

The printer controls registration in the digital printer 100 during the printing process in another embodiment that prints four or more colors as well as the thin film application, as shown in FIG. 1, wherein for each sheet at least one register mark per color printing unit of the multi-color printing machine is produced, assigned to said sheet and defined with respect to its position, preferably relative to one of the color marks themselves. These marks are applied preferably to a support for said sheets and preferably downstream of the respectively associated sheet, and, based on the determination of the position of the register marks of a sheet, the circumferential register of at least one sheet being controlled, said sheet following the sheet associated with said determined register marks downstream of the printing process, said device comprising at least one monitoring and control arrangement for detecting register marks, for determining at least relatively the positions of said register marks and for controlling the color printing units based on the aforementioned register mark positions, preferably for carrying out the aforementioned method.

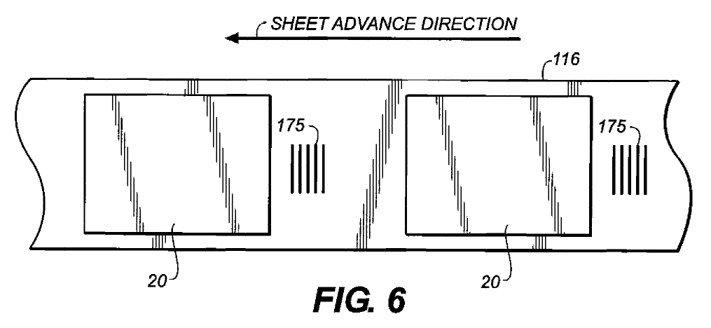

In this embodiment as shown in FIG. 6, for example, respectively five or six register marks can be made 175 against the transport direction for each module, including the thin film application module, and initially a type of guide mark could be applied, relative to which the position of the other register marks can be determined. This register mark could preferably be applied in black or produced by a printing unit using the “Key” color. As an aside, it should be mentioned that this is referred to as an “application” of register marks. Basically, this could also be referred to as “printing”; however, in an electrqphotographic (EP) printing machine, register marks are usually applied to the transport belt, photoconductor and/or an intermediate member only as toner, which is not fused in order to be able to better remove it again from the transport belt at a later time. However, it could be a matter of discussion whether an electrophotographic (EP) printing includes fusing or not. In this context, the concepts “printing”, “applying” and “creating” in conjunction with register marks are to be understood as being synonymous, should there be any doubt. Specifically meant is the generation of a recognizable and measurable register mark.

These register marks are then detected by a registration sensor 180 (register mark sensor) and can thus be analyzed as described in the incorporated references mentioned above. The analysis of the register marks permits an inventive control of the subsequent printing of sheets in the same printing process. The control on the basis of a register mark that has just been detected by registration sensor 180, however, can be used at the earliest for a sheet which arrives as the next sheet at the lead edge sensor 136, such as one before the thin film applicator, because the sheet still has all the other printing units ahead of it. However, because transport belt 116 is utilized better, additional sheets are already between any two sensors.

In the digital printer 100 as shown in FIG. 2, the analysis of the register marks can be used more elegantly for time-corrected printing so that imaging performed by each module is appropriately timed with the arrival of new information from registration sensor 180, and thus with the position of the next sheet arriving at lead edge sensor 136, and with said sheet's continued transport speed and the time of arrival in each nip is computed there from. In so doing, it may be taken into consideration that a large part of potentially occurring register errors has already been detected by calibration runs before an actual print job, and that said errors can be and are corrected by an appropriate preliminary calibration of the printing machine.

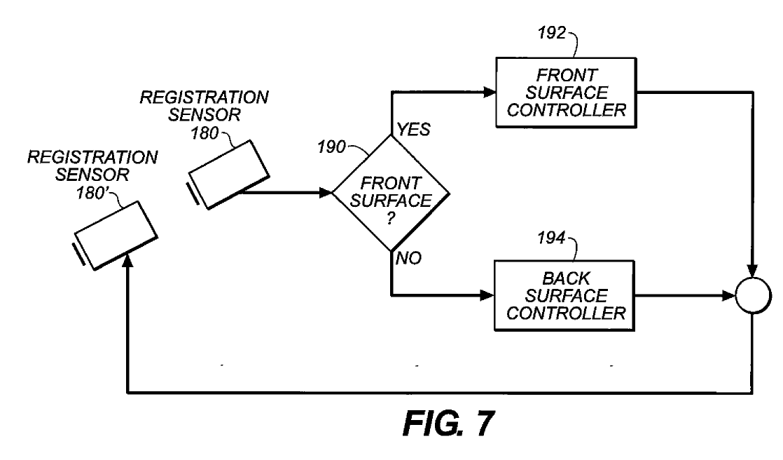

FIG. 7 shows a type of flow diagram of an inventive monitoring and control arrangement for control as has been described briefly above. The monitoring and control arrangement comprises, in particular, two registration sensors 180 or one registration sensor 180 which performs two functions and has been quasi-virtually doubled. This registration sensor 180 detects arrays of register marks 175, which, for simplicity's sake, are indicated only as fat bars in FIG. 7. The thusly yielded registration data are forwarded by registration sensor 180 to a query means 190, which queries if data come from register marks assigned to a front surface or recto printing side of a sheet (yes) or not (no), i.e., instead of being assigned to a reverse or verso printing side. If the response is yes, the data are analyzed by a front surface controller 192; if the response is no, the data are analyzed by a back surface controller 194. Based on this, control data are released, i.e., on one hand, back to registration sensor 180′ and, in particular, also to printing modules, including the thin film application module. Also, dual controllers 192, 194 may be available, namely physically or virtually.

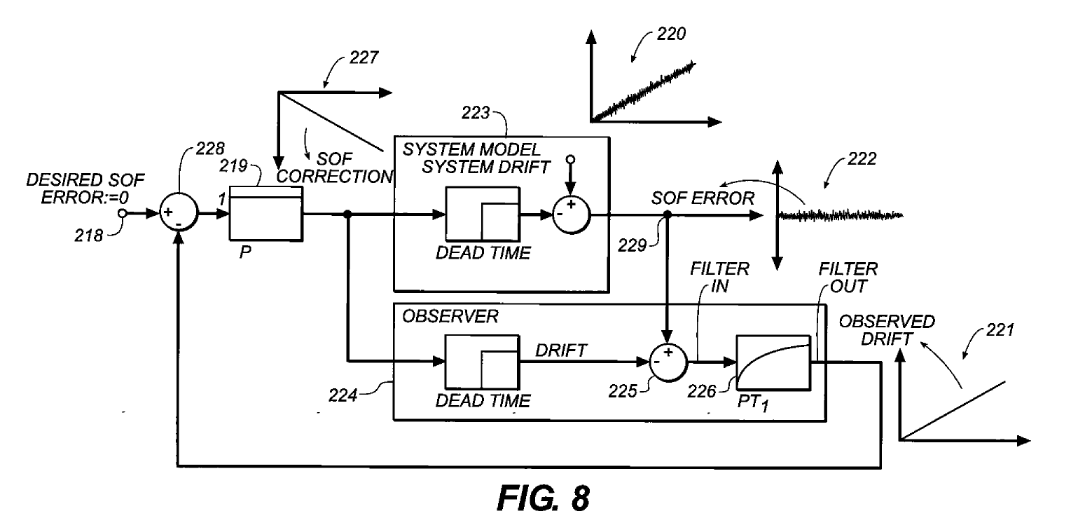

FIG. 8 shows a type of block circuit diagram of a monitoring and control arrangement, including a delay drift control that can be used in conjunction with the present invention. The characteristics of the delay drift control are used during the printing operation; a register mark is printed on the transport belt between respectively two printing material sheets, in which case each register mark preferably consists of a line. At least one register mark per active printing module or printing unit is printed. The registration sensor downstream of the last printing unit measures these marks, and, the measured values are used to determine the register, such as the circumferential register, of the sheet that directly preceded the register marks of an array. Consequently, deviations from the optimal register, i.e. circumferential register, are determined, and the register error of the subsequently following sheets is corrected accordingly relative to zero. This may be applicable at the earliest to the sheet, which is detected as the next sheet, for example, by a lead edge sensor, as described in greater detail in U.S. Ser. No. 11/847,868 which is incorporated by reference.

In the embodiment shown in FIG. 8 an imagined frame is pre-specified for the imaging region on the imaging cylinder. The time of the (chronological) beginning or start of this frame (Start of Frame—SOF) is controlled. Therefore, an error of circumferential registration can also be viewed as an SOF error, and this error should (by quasi definition) be equal to zero (NOMINAL value). This request (Desired SOF error: =0) is used at point 218 on entry into the monitoring and control arrangement in FIG. 8. In the illustrated control loop, a proportionality link 219 is labeled “P” only for the sake of completeness, which said link, in the present case, only multiplies an observed value 221 as control deviation—after it has been inverted at 228—with a proportionality factor “1”, i.e., remains unchanged, so that the observed value 21 becomes setting value 227, as indicated. How this observed value 221 or setting value 227 is determined or yielded will be described in detail hereinafter.

In a model of the viewed or observed system (system model) 223, it is assumed, using a controlled system as basis, that within the already described “dead time”, during which a sheet moves from lead edge sensor 180 to registration sensor 180′ and is processed by the LCU, the circumferential register assigned to this sheet is subject to a drift and to statistical noise, in which case said drift is to be quasi counter-controlled by reverse “presentation” for correction. For example, a substantially linear systematic drift (system drift) is assumed, which said drift is superimposed by said noise and over time leads to position changes of the register marks, as illustrated in region 220. This is the ACTUAL value which is generated in the system and which is present at point 229. If the drift is corrected out, as shown in region 222, only the statistical noise around the requested NOMINAL zero value (SOF value) remains, whereby said noise cannot be further removed by correction.

In order to achieve the desired control, the system is reproduced on the side of an “observer” via the control loop. On the observer 224 side of the observed system, the drift of the system is observed and taken into account in point 225 via the ACTUAL value obtained in point 229. In order to synchronize the observer with the system, the dead time already mentioned in conjunction with system model 223 must be taken into consideration.

The ACTUAL value obtained at point 225 from the system, as shown in region 220, is input—in order to smooth said value and eliminate the noise—as filter input data (FilterIn) in a filter 226 labeled “PT1”, said filter being essentially configured or acting as a low-pass filter. This is achieved by means of the following FilterIn algorithm shown below:

| | |
|---|---|
| (1) | FilterIn (i) = DriftCorrection (i − d) − RegError (i) |
| | = DriftCorrection (i − d) − {RegData (i) − |
| | DesiredValue} |

with the current control step i and dead time d. The parameters of said algorithm are largely self-explanatory, i.e., “FilterIn” represents the input value for filter 226, “DriftCorrection” represents the drift to be corrected in view of the dead time, “RegError” represents the registration error to be corrected, “RegData” represents the registered register mark data (ACTUAL values), and “DesiredValue” represents the desired register mark data (SET values). In so doing, the determination of the difference (i−d) takes into consideration that correction starts in the region of lead edge sensor 180, i.e., registered by dead time d earlier than the registration of register mark data in the region of registration sensor 180′ (at “time” i). This determination of the difference can also be understood as the determination of the average over this period of time.
The FilterOut then results due to filter 26 in terms of:

FilterOut(i)=a₀·FilterIn(i)+(1−a₀)·FilterOut(i−1) (2)

with the current control step i and the previous control step (i−1). a0 is a filter coefficient expressed in terms of:

$${a}_{0} = 1 - exp ( - \frac{Δ t}{τ} ) \qquad ( 3 )$$

where Δt is the time between the current and the previous control steps t(i)−t(i−1), and τ is a time constant of filter 226. Considering an artificial prespecified value, in particular an increase of Δt, the value of the filter coefficient or the weighting factor a0 can be varied and, thus, also portions of the two addends in equation (2) can be prespecified. This determines the degree of the “hardness” or “softness” that is being considered in view of current or previous data during control. In particular at the start of a printing process, initially a harder control should be preferable.

Finally, in equation (2), the FilterOut value, which is represented as the observed value (Observed Drift) and is shown in region 221, and the smoothed drift which has been freed of noise, as described above, are taken into consideration for the next control at point 228 in terms of:

DriftCorrection(i)=FilterOut(i) (4)

In any contact fusing the speed of fusing and resident times and related pressures applied are also important to achieve the particular final desired film layer. Contact fusing may be necessary if faster tunarounds are needed. Various finishing methods would include both contact and non-contact including heat, pressure, chemical as well as IR and UV. The described toner normally has a melting range between 50-150 degrees Celsius. An example of two types of toner that work well to adhere the digitally patterned foil include toner that is can be heated to a temperature close to the softening point (i.e. Tg) and/or has a relatively high molecular weight, such as the Kodak MICR toner. Toner that has a higher molecular weight and a high cohesive strength when in the melt state maximizes the adhesive force between the substrate and the thin film. Surface tension, roughness and viscosity should be such as to yield a efficient transfer. Surface profiles and roughness can be measured using the Federal 5000 “Surf Analyzer’ and is measured in regular units, such as microns. Toner particle size, as discussed above is also important since larger particles not only result in the desired heights and patterns but also results in a clearer thin film pattern layers since there is less air inclusions, normally, in a larger particle. Color density is measured under the standard CIE test by Gretag-Macbeth in colorimeter and is expressed in L*a*b* units as is well known. Toner viscosity is measured by a Mooney viscometer, a meter that measures viscosity, and the higher viscosities will keep an thin film pattern layer's pattern better and can result in greater height. The higher viscosity toner will also result in a retained form over a longer period of time.

Melting point, discussed above, is often not as important of a measure as the glass transition temperature (Tg). This range is around 50-100 degrees Celsius, often around 118 degrees Celsius. Permanence of the color and/or clear under UV and IR exposure can be determined as a loss of clarity over time. The lower this loss then the better the result. Clarity, or low haze, is important for thin film pattern layers that are transmissive or reflective wherein clarity is an indicator and haze is a measure of higher percent of transmitted light. When no cooling device is used prior to the separation of the thin film support from the substrate the toner preferably has a high cohesive strength when in the melt state to maximize its adhesive force to the thin film.

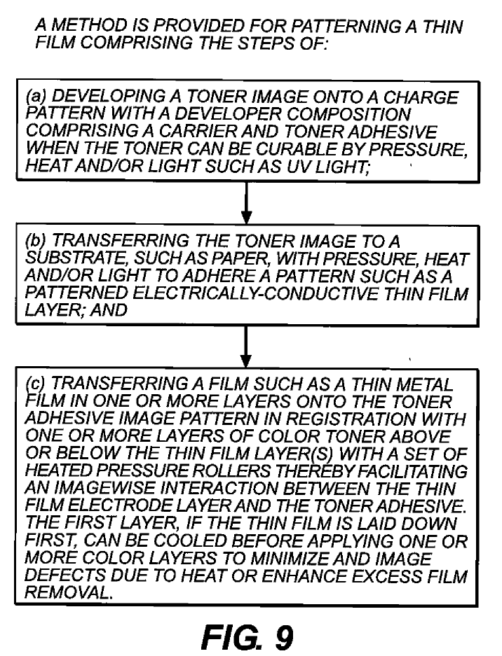

In one embodiment of the present invention, as shown in FIG. 9, a method is provided for patterning a thin film comprising the steps of: (a) developing a toner image on to a charge pattern with a developer composition comprising a carrier and toner adhesive; (b) transferring the toner image to a substrate, such as paper, with heat and or pressure to adhere a patterned electrically-conductive thin film layer; and (c) transferring a thin metal film unto the toner adhesive image pattern with a set of heated pressure rollers thereby facilitating an imagewise interaction between thin film electrode layer and the toner adhesive. The first layer, if the thin film is laid down first, can be cooled before applying one or more color layer to minimize and image defects due to heat.

The method shown in FIG. 9 can be used to form a thin film pattern, such as an electrode pattern, by an electrographic imaging process is an in line process on the printer including the steps of: (a) depositing one or more layers of one or more thin film adhesive toners pixel by pixel applied as a mask of the desired foil image possibly using a clear toner clear or alternatively using an inkjet printer head to perform this first step; (b) applying a thin film layer in registration, as described above, over the deposited adhesive toner using a hot roller to apply heat. It should be noted that a cold stamp foil will work in this process since there is heat that will be applied during the process and the toner will act as an adhesive so no additional supplied adhesive is required as is supplied with the so called “hot stamp foils”.

This could be done from the two positions as shown in FIGS. 4a and 4b, described above, and the toner could be UV curable and cured with a lamp shining from the center through the film to cure the adhesive toner as discussed above so that the fixing step includes (c) applying heat an/or pressure or other means, such as UV, to adhere the thin film at desired locations and optionally (d) depositing, in register, the digitally patterned thin film image (DPTFI) and one or more additional layers of one or more other colored toners over the adhered thin film layer, said toner substantially identical to the first toner; and fixing the final print.

Registration is controlled as described above between the color toner lay down for colored images and the thin film patterned toner image to adhere the thin film. Note that the colored toner could alternately be a clear toner having various characteristics. The registration of the colored toner layers to the DPTFI can be further improved by using feed forward and or feed back algorithms based on sensors that measure the location of the transport web and imaging elements in time and/or characterize the printing system in a mode prior to the printing mode. Algorithms that compensate for factors that cause the position of the substrate to be altered can be used to accurately register the subsequent toner images to the DPTFI. Alternatively, when a common transport web is not used for printing the DPTFI and the subsequent toner images, marks can be printed on the substrate when the DPTFI is created. These marks are read with sensors and used to accurately control the printing of the subsequent toner images. Another improvement to aid in registering the images is to accurately measure the position of the substrate by detecting the location of one or more edges of the substrate at specified locations. Edge detection can be used with any of the described techniques.

This method can use conductive metal films and produce electronic circuits and/or any metal or other films to produce desired decorative images including scratch-offs. The film can produce embossed items and can use raised clear to give height.

When marking toner(s) are applied on top of the DPTFI it is preferred that the toner(s) are not opaque so that a metallic color image is created. Thus the final image (after the final fusing step) contains a layer or layers of transparent or semi-transparent ink layers that allow the reflective properties of the DPTFI to be visualized. This method permits a wide variety of metallic colors to be created. An optional glossing step can also be used to produce a glossy decorative image. We have found that higher gloss marking images on top of the DPTFI produce more luster and thus using an in line or off line finishing step to create a glossier image is a preferred mode.

Another method of the present invention for forming a thin film pattern, such as an electrode pattern, by an electrographic imaging process is off line as shown in FIG. 2. This method includes the steps of: (a) depositing one or more layers of one or more thin film adhesive toners pixel by pixel applied as a mask of the desired foil image preferably using a clear toner such as in a single color machine like the Kodak Digimaster or alternatively using an inkjet printer head to perform this first step, and (b) depositing registration marks using said toners or ink, (c) applying the thin film and (d) applying heat an/or pressure or other means, such as UV, to adhere the thin film at desired locations, (e) in a separate device (an offline device) the registration marks are scanned and used to register the image to additional toner layers as described in the in line process above.

This method can use conductive metal films and produce electronic circuits and/or any metal or other films to produce desired decorative images including scratch-offs. The film can produce embossed items and can use raised clear to give height and could be used in conjunction to the first method for more options.

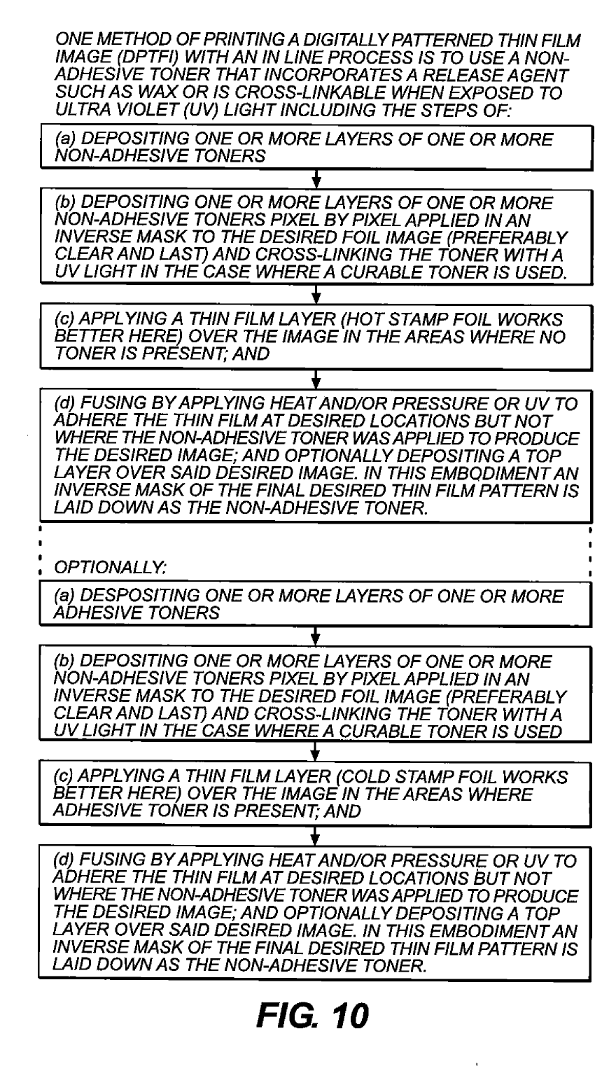

FIG. 10 shows one method of printing a DPTFI with an in line process is to use a non adhesive toner that incorporates a release agent such as wax or is cross-linkable when exposed to ultra violet (UV) light. This method includes the steps of: (a) depositing one or more layers of one or more non-adhesive toners b) depositing one or more layers of one or more non-adhesive toners pixel by pixel applied in an inverse mask or negative image of the desired foil image (preferably clear and last) and cross-linking the toner with a UV light in the case where a curable toner is used (c) applying a thin film layer (hot stamp foil works better here) over the image in the areas where no toner is present; and (d) fusing by applying heat and/or pressure or UV to adhere the thin film at desired locations but not where the non-adhesive toner was applied to produce the desired image; and optionally depositing a top layer over said desired image. In this embodiment an inverse mask of the final desired thin film pattern is laid down as the non-adhesive toner. The thin film non-adhesive negative image formed by similar methods described for an inverse mask in U.S. Pat. No. 7,340,208, which is incorporated by reference.

As described in this application a clear toner can be deposited so that the clear toner forms the negative image when the inverse mask mode is selected for the fifth image-forming module M5 in accordance with the information for establishing or printing a negative in clear toner in the referenced application. Image data for the clear toner negative is generated in accordance with paper type and the pixel-by-pixel locations as to where to apply the clear toner. Information regarding the multicolor image is analyzed by a Raster Image Processor (RIP) associated with the LCU 130 to establish on a pixel-by-pixel basis as to where pigmented toner is located on the thin film printed patterned receiver member. Pixel locations having relatively large amounts of pigmented toner are designated as pixel locations to receive a corresponding lesser amount of clear toner so as to balance the overall height of pixel locations with combinations of pigmented toner and clear toner. Thus, pixel locations having relatively low amounts of pigmented toner are provided with correspondingly greater amounts of clear toner. In the printing of the clear toner as an negative, the negative image data may be processed either as a halftone or continuous tone image. In the case of processing this image as a halftone, a suitable screen angle may be provided for this image to reduce moire patterns.

Further shown in FIG. 10 is another method of printing a DPTFI with an in line process that uses a non adhesive toner that incorporates a release agent such as wax or is cross-linkable when exposed to ultra violet (UV) light includes the steps of: (a) depositing one or more layers of one or more adhesive toners b) depositing one or more layers of one or more non-adhesive toners pixel by pixel applied to the desired foil image (preferably clear and last) and cross-linking the toner with a UV light in the case where a curable toner is used (c) applying a thin film layer (cold stamp foil works better here) over the image in the areas where adhesive toner is present; and (d) fusing by applying heat and/or pressure or UV to adhere the thin film at desired locations but not where the non-adhesive toner was applied to produce desired image; and optionally depositing a top layer over said desired image. In this embodiment the negative of the final desired thin film pattern is laid down as the non-adhesive toner.

The invention will be described and illustrated herein in connection with the patterning of thin film electrode layers by the techniques of electrophotography, electrophoretic migration imaging and modulated electrostatic printing. It will be readily understood by those skilled in the art that the invention will be in general, applicable to any electrographic technique which uses marking particles for defining image patterns.

1. A printing method for producing a registered thin film digitally patterned image upon a receiver, said printing comprising the steps of:
a. depositing a digitally patterned layer of toner at a thin film position to form a predetermined adhesive image that represents a thin film digitally patterned image and a color image on a first receiver sheet at a desired location;
b. applying one or more thin film image registration marks and one or more color toner registration marks including one or more marks applied on the support downstream of the first receiver sheet that is to have a thin film applied thereunto and defined with respect to a register mark position on the support
c. monitoring a registration of the thin film digitally patterned image relative to the color image by analyzing relative positions of thin film image registration marks and color toner registration marks;
d. controlling the printing process by correcting the thin film patterned image position using an automatic position controller responsive to the thin film registration marks; and
e. applying a thin film layer over the thin film digitally patterned adhesive image layer on the receiver based on the thin film registration mark; and
f. activating the digitally patterned adhesive image layer to adhere the thin film layer to create the thin film digitally patterned image by applying heat and/or pressure to adhere the thin film at desired locations.

2. The method of claim 1, wherein the controlling step further comprises providing information from both a thin film registration sensor and a color toner registration sensor to control the registration of the thin film digitally patterned image to the color image by adjusting the receiver so that the thin film digitally patterned image is accurately registered to the receiver.

3. The method of claim 2, wherein the controlling step further comprises controlling both the position and timing of the receiver so that the thin film digitally patterned image is registered to one or more color toner images including adjusting for skew and cross track alignment and the timing.

4. The method of claim 1, further comprising a separation step to separate non-adhered thin film from the thin film digitally patterned image.

5. The method according to claim 4, the separation step preceded by a cooling step.

6. The method according to claim 4, wherein said the thin film digitally patterned image comprises a pattern formed by toner with higher molecular weight toner having a high cohesive strength when in the melt state to maximize its adhesive force to the thin film.

7. The method according to claim 1, said applying the thin film step further comprising applying a thin film cold stamp foil over toner laid down as a negative image of the desired patterned thin film.

8. The method according to claim 7, further comprising laying down the negative image using an UV curable toner color toner and the film and curing the UV curable toner with a lamp shining from the center through the film to cure color toner before applying additional toner and treating all the toner with heat and pressure.

9. The method according to claim 7, further comprising laying down a complete layer of adhesive toner before laying down the negative image using wax based non-adhesive toner and treating all the toner with heat and pressure.

10. The method according to claim 1, said activating step further comprising applying heat and pressure at the same time the thin film layer is applied.

11. The method according to claim 1, said thin film layer further comprising a conductive metal film for producing electronic circuits.

12. The method according to claim 1, said thin film layer further comprising one or more of a metal and other film for producing embossed items.

13. The method according to claim 1 further comprising depositing one or more layers of raised print in conjunction to the deposition of the digitally patterned layer of toner and application of the thin film such that the raised clear will add height to the digitally patterned image.

14. The method according to claim 1 further comprising cooling a first thin film layer before applying one or more color layer.

15. An apparatus for producing a registered thin film digitally patterned image upon a receiver transported on a support, the apparatus comprising:
a. an imaging member to place an image on upon a receiver;
b. a controller for controlling the application of each layer to form the pattered thin film by applying one or more marks to the support downstream of a first receiver including applying at least one color registration mark applied relative to one or more thin film registration marks based on the position of the registration marks;
c. a register with one or more determined positions of the thin film registration marks relative to the color registration marks;
d. a development station for depositing one or more layers of toner to form a predetermined adhesive image that represents a thin film digitally patterned image;
e. an application device to apply a thin film layer over the digitally patterned image layer in registration to the thin film registration marks;
f. a monitoring device, interacting with the controller, for controlling printing by detecting the register marks and determining at least relatively the positions of said register marks, wherein for thin film patterned printing so that the monitoring and control arrangement is set up in such a manner that the positions of register marks assigned to the thin film printing is taken into consideration; and
g. a treatment device for treating the receiver to adhere to the digitally patterned image layer to said thin film layer to create said thin film digitally patterned image by applying heat and pressure.

16. The apparatus according to claim 15, further comprising at least two control sensors for detecting register marks of the pattered thin film printing and for at least relatively determining the positions of the register marks is provided.

17. The apparatus according to claim 16, further comprising a position adjustment device to adjust the receiver so that the thin film image is accurately registered to the receiver using one or more of in track, cross track, and skew adjustments made by an automatic sheet positioner that uses information from both a thin film registration sensor and a color toner registration sensor to control both the position and timing of the receiver so that the thin film image is registered to the color toner image that will be applied in the subsequent color toner transfer nip.

18. The apparatus according to claim 16, further comprising a position adjustment device to adjust for skew and cross track alignment and a timing adjustment device to enable the paper to be delivered to the color toner transfer nip so that it is accurately register in the in track direction.

19. The apparatus according to claim 15, wherein the controller further determines systematic drift during the control step.

20. The apparatus according to claim 15 wherein said digitally patterned image comprises a pattern by a high molecular weight polymer with high viscosity and a non-contact fuser to apply UV light to adhere the thin film at desired locations.

21. The apparatus according to claim 15 further comprising an applicator for applying a thin film cold stamp foil over the deposited adhesive toner and a hot roller to apply heat to activate said adhesive toner.

22. A thin film registered digitally patterned imaged receiver, said receiver comprising:
a. a digitally patterned layer of toner to form a predetermined digitally patterned adhesive image that represents a thin film digitally patterned image said thin film layer substantially unadhered in a first state,
b. one or more top layers of toner adjacent said thin film pattern layer; and
c. activatable toner in said digitally patterned layer of toner to create a thin film digitally patterned image after application of heat and pressure to adhere the thin film at a desired position.

23. The receiver according to claim 20, said thin film layer further comprising a metal film for producing one or more of an electronic circuits and a scratch-off.

24. The receiver according to claim 20, said thin film layer further comprising one or more of a metal and other film for producing embossed items.

25. The receiver according to claim 20, further comprising one or more layers of raised print in conjunction to the deposition of the digitally patterned layer of toner and application of the thin film, said to raised clear to give height.

26. A printing method for producing a thin film digitally patterned image upon a receiver, said printing comprising the steps of:
a. depositing a digitally patterned layer of toner at a thin film position to form a predetermined adhesive image that represents a thin film digitally patterned image and a color image on a first receiver sheet at a desired location;
b. applying a first thin film layer over the thin film digitally patterned adhesive image layer on the receiver;
c. activating the digitally patterned adhesive image layer to adhere the first thin film layer at desired locations;
d. cooling the first thin film layer;
e. applying one or more color layers on the first thin film layer; and
f. activating the digitally patterned adhesive image layer, including the color layers, to adhere the color layers at desired locations.

27. The method according to claim 1 further comprising depositing one or more layers of raised print in conjunction to the deposition of the digitally patterned layer of toner and application of the thin film and the color layers such that the raised clear will add height to the digitally patterned image.

28. A printing method for producing a thin film digitally patterned image upon a receiver, said printing comprising the steps of:
a. depositing a digitally patterned layer of toner at a thin film position to form a predetermined adhesive image that represents a thin film digitally patterned image and a color image on a first receiver sheet at a desired location;
b. applying a first thin film layer over the thin film digitally patterned adhesive image layer on the receiver;
c. depositing one or more layers of raised print in conjunction to the deposition of the digitally patterned layer of toner and application of the thin film such that the raised clear will add height to the digitally patterned image; and
d. activating the digitally patterned adhesive image layer to adhere the first thin film layer to create the thin film digitally patterned image to adhere the thin film at desired locations.

29. The method according to claim 28 further comprising cooling a first thin film layer before applying one or more color layers.
